(19) United States
(12) Patent Application Publication
(10) Pub. No.: US 2018/0009474 A1
(43) Pub. Date: Jan. 11, 2018

(54) STEERING CONTROL DEVICE

(71) Applicant: DENSO CORPORATION, Kariya-City (JP)

(72) Inventors: Hisaya AKATSUKA, Kariya-city (JP); Daiji WATANABE, Kariya-city (JP)

(21) Appl. No.: 15/644,123

(22) Filed: Jul. 7, 2017

(30) Foreign Application Priority Data
Jul. 11, 2016 (JP) 2016-136947

(51) Int. Cl. B62D 6/00; B62D 15/02; B60R 1/00

(52) U.S. Cl. CPC B62D 6/008; B62D 15/025; B60R 1/00

(57) ABSTRACT

In a control section in a drive assist system, a position prediction section acquires a direction of a road on which an own vehicle drives. A position identification section a drive direction of the own vehicle on the road. An assist control calculation section determines control parameters so that the direction of the road easily matches with the drive direction of the own vehicle. The control parameters represent a degree of steering operation due to the direction of the road.

### CROSS-REFERENCE TO RELATED APPLICATION

This application is related to and claims priority from Japanese Patent Application No. 2016-136947 filed on Jul. 11, 2016, the contents of which are hereby incorporated by reference.

### BACKGROUND OF THE INVENTION

### 1. Field of the Invention

The present invention relates to steering control devices capable of executing steering control of an own vehicle.

### 2. Description of the Related Art

A patent document 1, Japanese patent laid open publication No. 2010-105454, has disclosed a steering control device capable of adjusting control parameters of a steering device according to conditions of a road on which an own vehicle drives, and surrounding road environment.

In order to provide safe driving of the own vehicle when the driver of the own vehicle operates the steering device, it is sufficient for the steering control device to maintain a current steering angle. However, this control reduces a degree of turning ability of the steering wheel of the own vehicle. In other words, there is a trade-off relationship between stable steering and turning ability of the own vehicle.

The steering control device disclosed in the patent document 1 previously described executes a control process so as to provide and maintain the stable steering control, but does not consider a degree of turning ability of the own vehicle when the own vehicle turns right or left. Accordingly, this conventional steering control provides reduced comfortable operability of the steering device of the own vehicle.

### SUMMARY

It is therefore desired to provide a steering control device capable of executing comfortable steering control of a steering device of an own vehicle, which provides stable steering control when a driver of the own vehicle operates the steering device, and provides improved turning ability of the own vehicle simultaneously.

An exemplary embodiment provides a steering control device which executes steering control of an own vehicle. The steering control device, i.e. a drive assist system has a road direction acquiring section, a drive direction acquiring section, and a control parameter determination section. The road direction acquiring section acquires a direction of a road on which the own vehicle drives. The drive direction acquiring section acquires a drive direction of the own vehicle. The control parameter determination section determines control parameters so that the direction of the road acquired by the road direction acquiring section easily coincides with the drive direction of the own vehicle acquired by the drive direction acquiring section. The control parameters represent a degree of steering operation due to the direction of the road.

According to the steering control device, i.e. the drive assist system having the improved structure previously described, because the control parameters are determined so that the direction of the road becomes match with the drive direction of the own vehicle, it is possible to provide the stable operation using the steering wheel when the direction of the road matches with the drive direction of the own vehicle, and to increase the turning ability of the steering wheel of the own vehicle so as to match the direction of the road with the drive direction of the own vehicle when the direction of the road does not match with the drive direction of the own vehicle.

When the own vehicle turns right or left, this control makes it possible to provide the improved turning ability of the steering wheel of the own vehicle while maintaining the stable steering operation using the steering wheel.

### BRIEF DESCRIPTION OF THE DRAWINGS

A preferred, non-limiting embodiment of the present invention will be described by way of example with reference to the accompanying drawings, in which:

FIG. 1 is a block diagram showing a structure of a drive assist system 1 as a steering control device to be amounted on an own vehicle according to an exemplary embodiment of the present invention;

FIG. 2 is a view showing functional blocks of a control section 10 in the drive assist system 1 as the steering control device according to the exemplary embodiment of the present invention;

FIG. 3 is a view showing a block diagram showing functions of an assist control calculation section 50 in the control section 10 in the drive assist system 1;

FIG. 4 is a flow chart showing a control parameter setting process executed by the control section in the drive assist system 1 according to the exemplary embodiment of the present invention;

FIG. 5 is a flow chart showing a process of detecting a steering angle increase state of the steering wheel of the own vehicle executed by the control section in the drive assist system 1 according to the exemplary embodiment of the present invention;

FIG. 6 is a flow chart showing a process of detecting a steering angle return state of the steering wheel of the own vehicle executed by the control section in the drive assist system 1 according to the exemplary embodiment of the present invention;

FIG. 7 is a flow chart showing a steering timing judgment process executed by the control section in the drive assist system 1 according to the exemplary embodiment of the present invention;

FIG. 8 is a view showing an example of various control parameters, to be determined in the steering timing judgment process shown in FIG. 7 executed by the control section in the drive assist system 1;

FIG. 9 is a flow chart showing a process of setting a curvature parameter executed by the drive assist system 1 according to the exemplary embodiment of the present invention;

FIG. 10A is a view showing a relationship between a rigidity gain and a curvature of a road on which the own vehicle drives;

FIG. 10B is a view showing a relationship between a viscosity gain and the curvature of the road on which the own vehicle drives;

FIG. 10C is a view showing a relationship between an assist amount and the curvature of the road on which the own vehicle drives;

FIG. 11 is a flow chart showing a slope parameter setting process;

FIG. 12A is a view showing a relationship between the rigidity gain and a degree of a slope of a uphill road on which the own vehicle drives;

FIG. 12B is a view showing a relationship between the viscosity gain and the degree of the slope of the uphill road on which the own vehicle drives;

FIG. 12C is a view showing a relationship between the assist amount and the degree of the slope of the uphill road on which the own vehicle drives;

FIG. 13 is a flow chart showing a smoothing filter superimposing process executed by the drive assist system 1 according to the exemplary embodiment of the present invention; and

FIG. 14 is a view showing functional blocks of a control section 10-1 in the drive assist system 1 according to a modification of the exemplary embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### EXEMPLARY EMBODIMENT

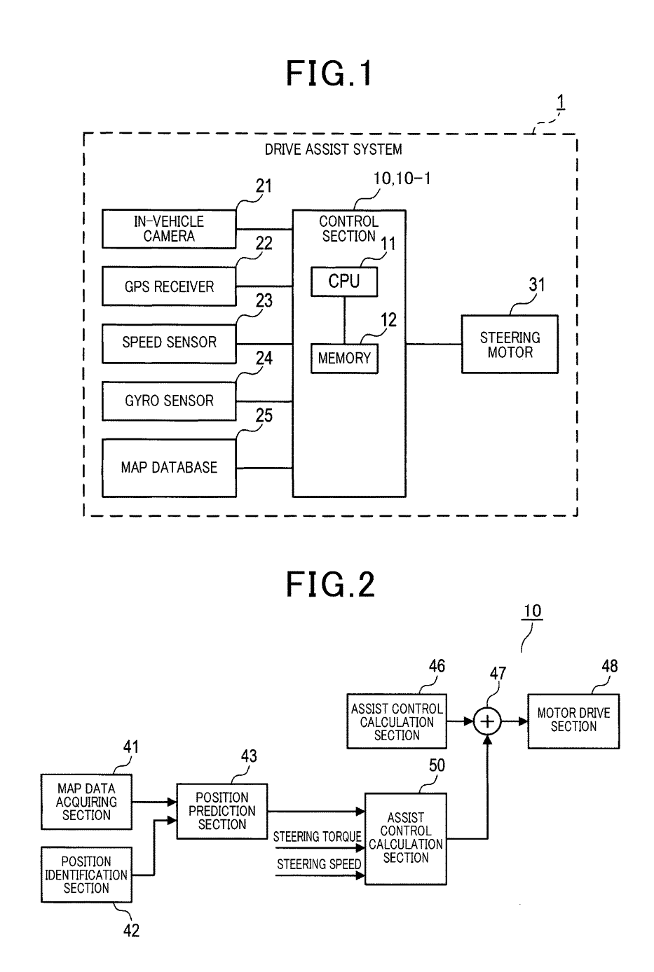

A description will be given of a drive assist system 1 as a steering control device to be mounted on an own vehicle with reference to FIG. 1 to FIG. 14.

### (Structure)

FIG. 1 is a block diagram showing a structure of the drive assist system 1 as the steering control device according to an exemplary embodiment.

The drive assist system 1 is mounted on the own vehicle such as a passenger vehicle, etc., and provides a drive assist to the driver of the own vehicle. In particular, the drive assist system 1 according to the exemplary embodiment provides an assist control of the steering wheel of the own vehicle on which the drive assist system 1 is mounted.

The drive assist system 1 shown in FIG. 1 has a control section 10. The drive assist system 1 has an in-vehicle camera 21, a GPS (Global Positioning System) receiver, a speed sensor 23, a gyro sensor 24, a map database 25, a steering motor 31, etc. The GPS represents a space-based radio-navigation system.

The in-vehicle camera 13 captures a forward view of the own vehicle and transmits a captured image to the control section 10. The GPS receiver 22 is a well-known device which receives radio waves transmitted from a GPS satellite, and detects a current position of the own vehicle on a road on the basis of the received radio waves.

The speed sensor 23 is a well-known sensor which detects a current speed of the own vehicle. The gyro sensor is a well-known device which detects a rotary angular speed of the own vehicle. The map database 25 stores known map information in which latitude and longitude on the earth correspond to road data. For example, the road data show a relationship between the location or position of a road, road shape information (which will be explained later), etc.

In order to specify the direction of the road on which the own vehicle drives, it is sufficient to use the road data including directional information which represents which direction the road is linked. That is, it is sufficient for the road data to show a curvature of a road and a degree of a slope at every position on the road. The exemplary embodiment uses the road data which include a curvature at an optional position on a road, and a degree of a slope at optional position on the road.

The steering motor 31 provides a rotation power, i.e. a torque to a mechanical assembly of a known power steering control device so as to change a steering angle. That is, the control section 10 instructs the steering motor 31 to provide a rotation power to the mechanical assembly in the power steering control device. This means that the control section 10 executes the drive assist.

The control section 10 is composed of a known microcomputer which has a central processing unit 11 (CPU 11), a semiconductor memory (hereinafter, the memory 12) such as a random access memory (RAM), a read only memory (ROM), a flash memory, etc. The control section 10 executes programs stored in a non-transitory computer readable storage medium as the semiconductor memory 12.

The execution of the programs stored in the memory 12 provides the method according to the exemplary embodiment of the present invention which will be explained in detail later. Storage mediums using electromagnetic wave are eliminated from the non-transitory computer readable storage medium. It is acceptable for the control section 10 to have one or more microcomputers.

FIG. 2 is a bloc diagram showing functions of the control section 10 in the drive assist system 1 as the steering control device according to the exemplary embodiment. As shown in FIG. 2, the control section 10 has plural functional blocks, i.e. a map data acquiring section 41, a position identification section 42, a position prediction section 43, an assist control calculation section 46, an addition section 47, a motor drive section 48, and an assist control calculation section 50. That is, when executing the programs stored in the memory 12, the control section 10 provides the functions of those sections such as the map data acquiring section 41, the position identification section 42, the position prediction section 43, the assist control calculation section 46, the addition section 47, the motor drive section 48, and the assist control calculation section 50.

It is also acceptable to use one or more hardware devices so as to realize one or more functions of those sections 41 to 43, 46 to 48 and 50. For example, when a function is realized by using a hardware device, it is acceptable to use a digital circuit, an analogue circuit, or a combination of a digital circuit and an analogue circuit composed of plural logical circuits.

The map data acquiring section 41 in the control section 10 of the drive assist system 1 according to the exemplary embodiment acquires road shape information from the map data base 25. The road shape information is used for determining the direction of the road on which the own vehicle drives. The road shape information represents information to be used for obtaining the direction of the road. For example, the road shape information includes a curvature of the road, a degree of a slope of the road, etc. on which the own vehicle drives.

The road shape information further includes a rear side position of the road at which the own vehicle has passed, the current position of the own vehicle on the road, and a forward position in front of the current position of the own vehicle on the road.

It is acceptable that the road shape information obtained by the map data acquiring section 41 corresponds to the road shape information which has been stored in the map database 25. It is also acceptable to obtain the road shape information on the basis of the information stored in the map database 25. Specifically, when the map database 25 has stored information regarding the curvature of the road and the degree of the slope of the road on which the own vehicle drives, it is sufficient for the map data acquiring section 41 to acquire the information regarding the curvature of the road and the degree of the slope of the road from the map database 25. On the other hand, if the map database 25 does not store any information regarding the curvature of the road and the degree of the slope of the road, it is sufficient for the map data acquiring section 41 to generate the information regarding the curvature of the road and the degree of the slope of the road on the basis of coordinate information of a node and a link and use, as the road shape information, the generated information regarding the curvature of the road and the degree of the slope of the road on which the own vehicle drives.

The position identification section 42 in the control section 10 of the drive assist system 1 according to the exemplary embodiment obtains a drive direction of the own vehicle and a speed of the own vehicle on the basis of the information transmitted from the GPS receiver 22 and the gyro sensor 24. The position identification section 42 further executes a matching process, i.e. an identification process so as to match the map data obtained from the map database 25 with the current position of the own vehicle.

The position prediction section 43 in the control section 10 of the drive assist system 1 according to the exemplary embodiment predicts a position of the own vehicle on the road in a future, and estimates the direction of the road on which the own vehicle drives according to the road shape information on the basis of the results of the identification process of the position of the own vehicle, the driving direction and driving speed of the own vehicle.

The position prediction section 43 uses a steering time which is obtained by adding a predetermined setting-time period of N seconds to a current time. The position prediction section 43 acquires a curvature of the road at the position through which the own vehicle has passed t seconds before the steering time or through which the own vehicle would pass t seconds after the steering time. The larger the curvature of the road is, the smaller the curvature radius is. In this case, the current road changes a sharp curve road.

Similarly, the position prediction section 43 obtains, i.e. calculates a degree of a slope at the position of the road through which the own vehicle would pass N seconds later. The position prediction section 43 transmits the curvature of the road, the degree of the slope of the road and the steering timing to the assist control calculation section 50

The assist control calculation section 46 calculates an assist control amount to be used by the steering control process. For example, like a known method and structure, the assist control calculation section 46 multiplies a steering torque and a predetermined gain together so as to obtain the assist control amount.

The addition section 47 adds the control amount calculated by the assist control calculation section 50 and the assist control amount calculated by the assist control calculation section 46.

When receiving the output value as the addition result of the addition section 47, the motor drive section 48 drives the steering motor 31 on the basis of the output from the addition section 47

The assist control calculation section 50 determines control parameters which represents a degree of steering operation to the steering wheel of the own vehicle according to the direction of the road so that the direction of the road matches with the drive direction of the own vehicle. The drive assist system 1 according to the exemplary embodiment uses, as the drive direction of the own vehicle, the direction of the road obtained on the basis of the curvature of the road at the current position of the own vehicle on the road.

The control parameters represent one or more control values which affect the steering control amount obtained by the assist control calculation section 50. For example, the control parameters include a resistance degree of the steering operation using the steering wheel, a steering stability of the steering operation, a turning ability of the own vehicle, steering set values, and in particular, a mechanical impedance of the steering mechanism. The steering mechanism transmits the power to the vehicle wheels of the own vehicle.

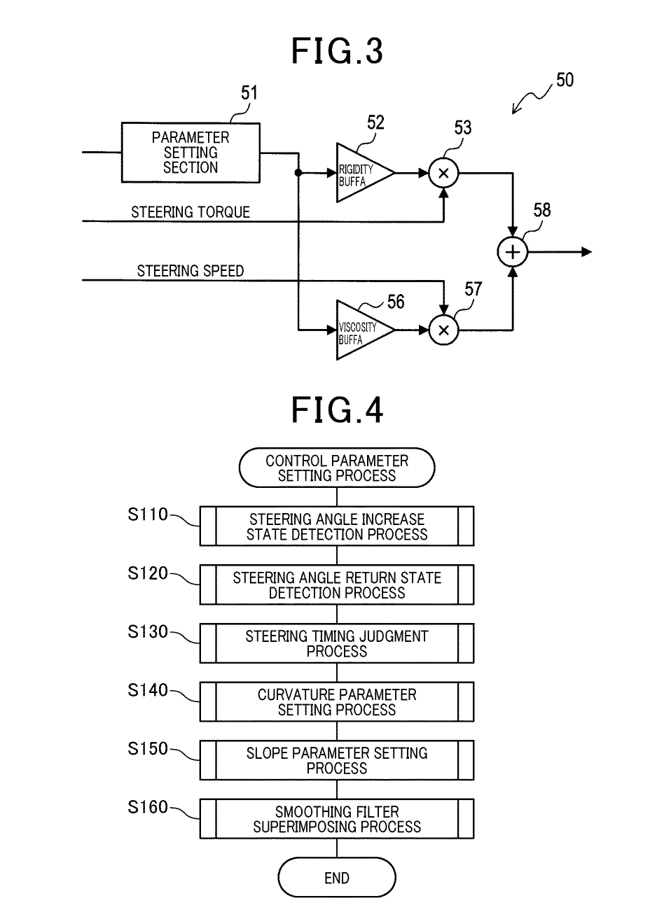

FIG. 3 is a view showing a block diagram showing plural functions of the assist control calculation section 50 in the control section 10 in the drive assist system 1. In more detail, the assist control calculation section 50 has plural functional blocks, i.e. a parameter setting section 51, a rigidity buffer 52, a rigidity multiplication section 53, a viscosity buffer 56, a viscosity multiplication section 57 and an assist addition section 58.

The assist control calculation section 50 determines, as control parameters, at least one of a viscosity component, a rigidity component and a steering assist amount. The viscosity component and the rigidity component are mechanical impedances of the steering mechanism of the own vehicle.

The parameter setting section 51 executes a control parameter setting process which will be explained later. The control parameter setting process generates and transmits control parameters which correspond to the curvature of the road, the degree of the slope of the road and the steering timing.

The control parameters represent various control amounts, and transmitted to the assist control calculation section 46, the rigidity buffer 52, and the viscosity buffer 56. The parameter setting section 51 changes those control parameters.

The rigidity buffer 52 receives the control parameter transmitted from the parameter setting section 51, multiplies the received control parameter with a predetermined rigidity gain, and transmits an output value as the multiplication result to the rigidity multiplication section 53. For example, the rigidity buffer 52 generates the output value so as to contain rigidity characteristics of an elastic member.

The rigidity multiplication section 53 receives the output transmitted from the rigidity buffer 52, and multiplies the received output with the steering torque, and outputs an output value as the multiplication result to the assist addition section 58.

The viscosity buffer 56 receives the control parameter transmitted from the parameter setting section 51, and multiplies the received control parameter with a predetermined viscosity gain, and transmits an output value as the multiplication result to the viscosity multiplication section 57.

For example, the viscosity buffer 56 generates the output value so as to contain damper characteristics.

The viscosity multiplication section 57 receives the output value transmitted from the viscosity buffer 56 and information regarding the steering torque, multiplies the received output value with the received steering torque, and transmits an output value as the multiplication result to the addition section 47.

### (Processes)

Next, a description will now be given of the control parameter setting process executed by the control section 10 in the drive assist system 1 as the steering control device according to the exemplary embodiment with reference to the flow chart shown in FIG. 4.

The drive assist system 1 starts to execute the control parameter setting process when the power source supplies electric power to the drive assist system 1. The drive assist system 1 repeatedly executes the control parameter setting process to generate the control parameters to be supplied to the rigidity buffer 52 and the viscosity buffer 56.

FIG. 4 is a flow chart showing a control parameter setting process executed by the control section 10 in the drive assist system 1 according to the exemplary embodiment.

In step S110 shown in FIG. 4, the control section 10 executes a steering angle increase state detection process. That is, the control section 10 detects whether the steering angle increase state of the steering wheel occurs. The steering angle increase state of the steering wheel of the own vehicle represents an increase state of turn of the steering wheel of the own vehicle. In more detail, the control section 10 detects whether the steering angle of the steering wheel increases from a straight steering angle in which the own vehicle moves straight forward.

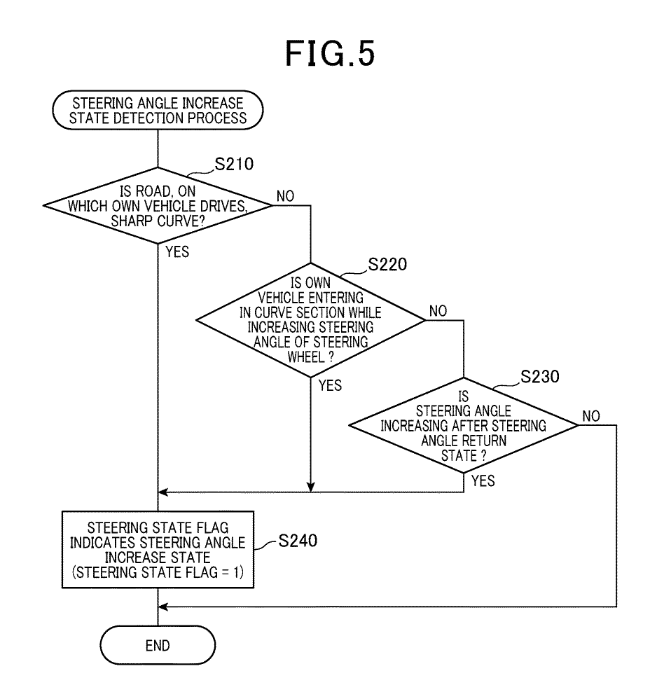

FIG. 5 is a flow chart showing the process of detecting the steering angle increase state of the steering wheel of the own vehicle executed by the control section 10 in the drive assist system 1 according to the exemplary embodiment.

In step S210 shown in FIG. 5, the control section 10 detects whether the road, on which own vehicle drives, is a sharp curve road. The control section 10 detects that the road is a sharp curve road when an absolute value of the curvature of a forward position on the road, through which the own vehicle would pass N seconds later, is less than a predetermined reference curvature, and the curvature of the current position on the road which has been previously detected is not less than a first reference curvature.

In this process, in particular, the control section 10 detects whether the current position of the own vehicle on the road is changed from a straight section or a relatively loose curve section to a sharp curve section on the road.

When the detection result indicates affirmation (“YES” in step S210), i.e. indicates that the road is a sharp curve section, the operation flow progresses to step S240.

On the other hand, when the detection result indicates negation (“NO” in step S210), i.e. indicates that the road is not a sharp curve road, the operation flow progresses to step S220.

In step S220, the control section 10 detects whether the own vehicle is entering on a curve section of the road while increasing the steering angle of the steering wheel of the own vehicle.

In step S220, the control section 10 detects that the own vehicle is entering in a curve section on the road while increasing the steering of the steering wheel when the absolute value of the curvature of the forward position on the road, through which the own vehicle would pass N seconds later, is less than a second reference curvature, and a change direction of the curvature of the road matches with the curved direction of the road.

The control section 10 determines the first reference curvature which is not more than the second reference curvature.

When the own vehicle is entering a curve section on the road while increasing the steering angle of the steering wheel, the operation flow progresses to step S240.

On the other hand, when the own vehicle does not enter any curve section on the road without increasing the steering angle of the steering wheel, the operation flow progresses to step S230.

In step S230, the control section 10 detects whether the steering angle of the steering wheel increases, i.e. the steering angle increase state occurs after a steering angle return state of the steering wheel of the own vehicle.

In step S230, the control section 10 detects a curvature of the road on which the own vehicle drives, and detects that the steering angle increase state occurs after a steering angle return state of the steering wheel of the own vehicle when the detected curvature of the road is changed from a positive curvature to a negative curvature or a negative curvature to a positive curvature, and when a right curve section is changed to a left curve section on the road, or a left curve section is changed to a right curve section on the road.

For example, a left curve section has a positive curvature and a right curve section has a negative curvature.

When the detection result in step S230 indicates affirmation (“YES” in step S230), i.e. indicates that the steering angle increase state occurs after the steering angle return state, the operation flow progresses to step S240.

In step S240, the control section 10 sets a value of 1 to a steering state flag (Steering state flag=1). The steering state flag has a value of 1 or 0 which represents a steering state of the steering wheel. When the steering state flag has the value of 1, the steering wheel is in the steering angle increase state. On the other hand, when the steering state flag has the value of 0, the steering wheel is in the steering angle return state.

When the detection result in step S230 indicates negation (“NO” in step S230), i.e. indicates that the steering angle increase state does not occurs after the steering angle return state, the control section 10 finishes the steering angle increase detection process shown in FIG. 5.

Next, the operation flow progresses to step S120 in the control parameter setting process shown in FIG. 4. In step S120, the control section 10 executes the steering angle return state detection process. That is, the control section 10 detects whether the steering angle return state of the steering wheel occurs. The steering angle return state of the steering wheel of the own vehicle represents the steering angle of the steering wheel is changed to a steering angle when the own vehicle is driving straight forward. In more detail, the control section 10 detects whether the steering angle of the steering wheel returns to the steering angle when the own vehicle moves straight forward.

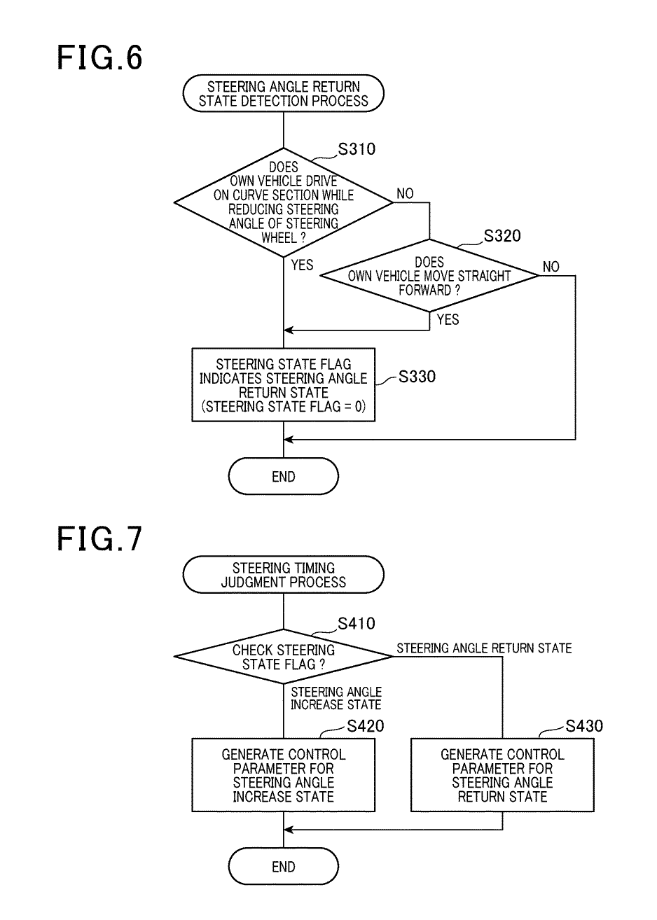

FIG. 6 is a flow chart showing the process of detecting the steering angle return state of the steering wheel of the own vehicle executed by the drive assist system 1 according to the exemplary embodiment.

In step S310 shown in FIG. 6, the control section 10 detects whether the own vehicle drives on a curve section on the road and the steering angle of the steering wheel reduces. For example, the control section 10 detects that the own vehicle drives on a curve section on the road while reducing the steering angle of the steering wheel when an absolute value of a curvature of a forward position on the road, through which the own vehicle would pass N seconds later, is less than the predetermined reference curvature and a change direction of the curvature of the road matches with a curve direction of the road.

In this process, it is acceptable for the control section 10 to use the first reference curvature or the second reference curvature as the predetermined reference curvature.

When the detection result indicates affirmation (“YES” in step S310), i.e. indicates that the own vehicle drives on a curve section on the road and the steering angle of the steering wheel reduces, the operation flow progresses to step S330.

On the other hand, when the detection result indicates negation (“NO” in step S310), i.e. indicates that the own vehicle does not drive on a curve section on the road and the steering angle of the steering wheel does not reduce, the operation flow progresses to step S320.

In step S320, the control section 10 detects that the own vehicle drives straight forward. For example, in step S320, the control section 10 detects that the own vehicle moves straight forward when an absolute value of a change amount of the curvature of the road is less than a predetermined change regulation value.

When the detection result in step S320 indicates affirmation (“YES” in step S320), i.e. indicates that the own vehicle is driving straight forward, the operation flow progresses to step S330.

In step S330, the control section 10 sets a value of 0 to a steering state flag (Steering state flag=0).

As previously described, the steering state flag has the value of 1 or 0 which represents the steering state of the steering wheel. When the steering state flag has the value of 0, the steering wheel is in the steering angle return state.

When the detection result in step S320 indicates negation (“NO” in step S230), i.e. indicates that the own vehicle does not move straight forward, the control section 10 finishes the steering angle return detection process shown in FIG. 6.

Next, the operation flow progresses to step S130 in the control parameter setting process shown in FIG. 4. In step S130, the control section 10 executes a steering timing judgment process. In the steering timing judgment process, the control section 10 adjusts various control parameters which correspond to the state of the own vehicle, i.e. which correspond to either the steering angle increase state or the steering angle return state of the steering wheel of the own vehicle.

FIG. 7 is a flow chart showing the steering timing judgment process executed by the control section 10 in the drive assist system 1 according to the exemplary embodiment.

In step S410 in the steering timing judgment process shown in FIG. 7, the control section 10 detects a value of the steering state flag.

When the detection result in step S410 indicates the steering angle increase state (the steering state flag=1), the operation flow progresses to step S420.

In step S420, the control section 10 generates the control parameter for the steering angle increase state. The control section 10 finishes the steering timing judgment process shown in FIG. 7.

On the other hand, when the detection result in step S410 indicates the steering angle return state (the steering state flag=0), the operation flow progresses to step S430.

In step S430, the control section 10 generates the control parameter for the steering angle return state. The control section 10 finishes the steering timing judgment process shown in FIG. 7.

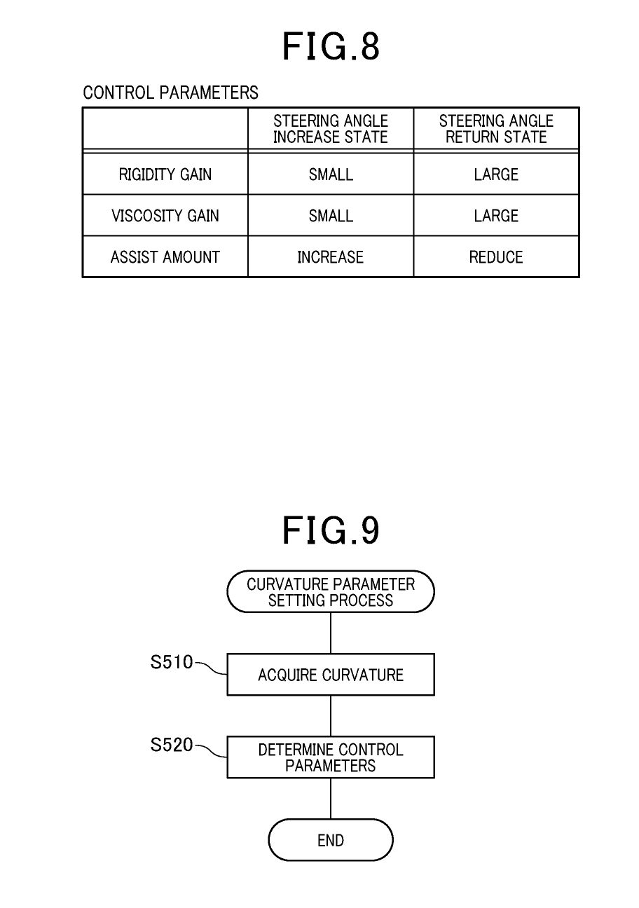

FIG. 8 is a view showing an example of various control parameters, to be determined in the steering timing judgment process shown in FIG. 7 executed by the control section 10 in the drive assist system 1. As shown in FIG. 8, the parameter setting section 51 in the control section 10 adjusts the control parameters to be transmitted to the rigidity buffa 52, and the viscosity buffa 56 so that the rigidity gain amplified by the rigidity buffa 52 and the viscosity gain amplified by the viscosity buffa 56 in the steering angle increase state become smaller than those rigidity gain amplified by the rigidity buffa 52 and the viscosity gain amplified by the viscosity buffa 56, respectively in the steering angle return state.

Further, the assist control calculation section 46 adjusts the assist amount so that the assist amount in the steering angle increase state become greater than the assist amount in the steering angle return state.

As previously described, when the steering wheel of the own vehicle is at an optional steering angle, the control section 10 or the parameter setting section 51 in the control section 10 adjusts the control parameters to be transmitted to the rigidity buffer 52 and the viscosity buffa 56, and further adjusts the assist amount, etc. so that the resistance degree of the steering operation using the steering wheel in the steering angle increase state becomes smaller than that in the steering angle return state.

The control section 10 adjusts the control parameters so that the moving direction of the own vehicle N seconds later matches with the forward expansion direction at the position on the road, through which the own vehicle would pass N seconds later.

For example, when a necessary amount of the control parameter at the current time is zero, and a necessary amount of the control parameter N seconds later is one, the control section 10 or the parameter setting section 51 in the control section 10 does not generate and transmits the control parameter of one, but generates the control parameter so as to gradually increase the control amount of the control parameter from zero to one.

Next, the operation flow progresses to step S140 shown in FIG. 4. In step S140, the parameter setting section 51 in the control section 10 executes the curvature parameter setting process which adjusts the control parameter due to a magnitude of the curvature of the road on which the own vehicle drives. That is, the parameter setting section 51 in the control section 10 determines the control parameter so the resistance degree of the steering operation using the steering wheel is reduced due to the increasing of the curvature of the road.

FIG. 9 is a flow chart showing the process of setting the curvature parameter executed by the control section 10 in the drive assist system 1 according to the exemplary embodiment.

In step S510 shown in FIG. 9, the parameter setting section 51 acquires a curvature of the forward section on the road, through which the own vehicle would pass N seconds later. The operation flow progresses to step S520.

In step S520, the parameter setting section 51 determines the control parameter which corresponds to the curvature of the road acquired in step S510.

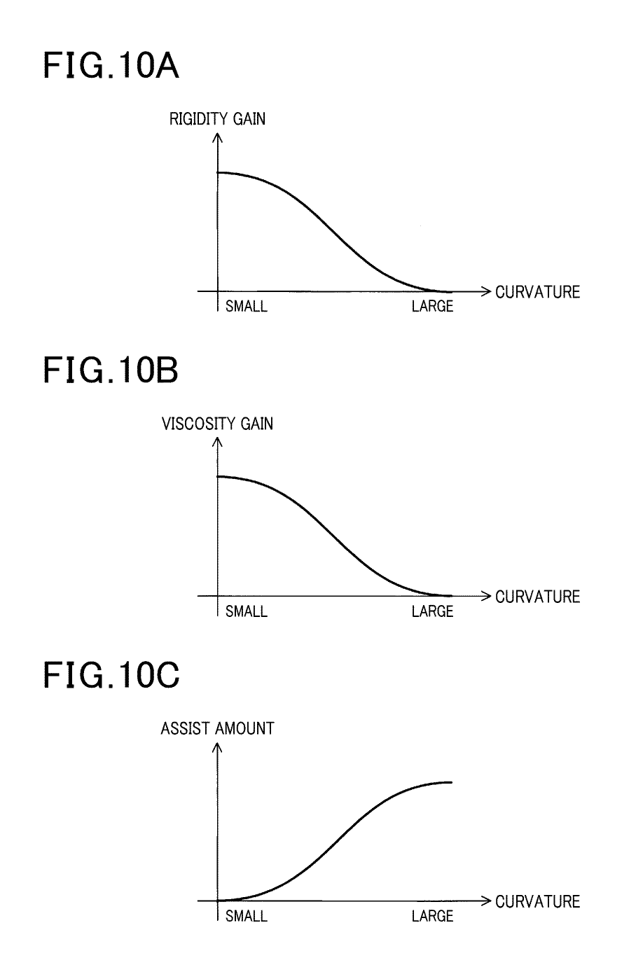

It is possible for the parameter setting section 51 determines the various control parameters on the basis of the maps shown in FIG. 10 A to FIG. 10C.

FIG. 10A is a view showing a relationship between the rigidity gain and the curvature of the road on which the own vehicle drives. FIG. 10B is a view showing a relationship between the viscosity gain and the curvature of the road on which the own vehicle drives. FIG. 10C is a view showing a relationship between the assist amount and the curvature of the road on which the own vehicle drives.

That is, as shown in FIG. 10A to FIG. 10C, the parameter setting section 51 determines the rigidity gain, the viscosity gain and the assist amount due to the magnitude of the curvature of the road.

The parameter setting section 51 adjusts the rigidity gain, the viscosity gain so that each of the rigidity gain and the viscosity gain is reduced according to increase of the curvature of the road. On the other hand, the parameter setting section 51 adjusts the assist amount so that the assist amount is increased according to increase of the curvature of the road.

In the control parameter setting process shown in FIG. 4, the control section 10 and/or the parameter setting section 51 in the control section 10 determines each identical control parameter plural times. It is acceptable for each identical control parameter to have a combination of optional values. For example, so as to obtain new control parameters, it is acceptable for the control section 10 or the parameter setting section 51 to execute arithmetic operations such as an addition, a subtraction, a multiplication, etc. by using the control parameters obtained in one process, or to calculate a weighted average of the control parameters obtained in one process.

It is also acceptable for the control section 10 or the parameter setting section 51 to use one control value only as the control parameter. The control section 10 finishes the curvature parameter setting process shown in FIG. 9 and in step S140 shown in FIG. 4.

Next, the operation flow progresses to step S150 shown in FIG. 4. In step S150, the control section 10 executes the slope parameter setting process. In the slope parameter setting process, the control section 10 adjusts and determines the control parameters due to a degree of the slope of the road on which the own vehicle drives. For example, the control section 10 adjusts and determines the control parameters so that the resistance degree of the steering operation using the steering wheel is reduced due to the increase of a degree of the slope of the uphill road.

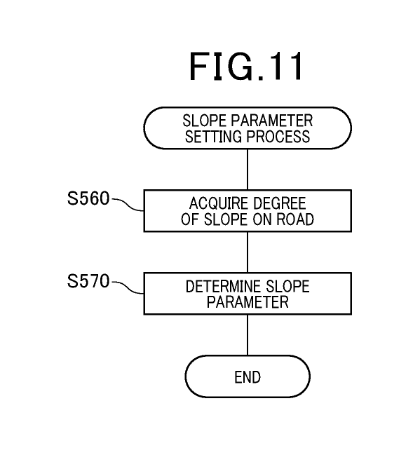

FIG. 11 is a flow chart showing the slope parameter setting process of determining the slope parameter of the road.

In step S560 in the slope parameter setting process shown in FIG. 11, the control section 10 acquires a degree of a slope at a forward point on the road, on which the own vehicle would pass N seconds later. The operation flow progresses to step S570.

In step S570, the control section 10 determines the slope parameter as the control parameter according to the degree of the slope of the road.

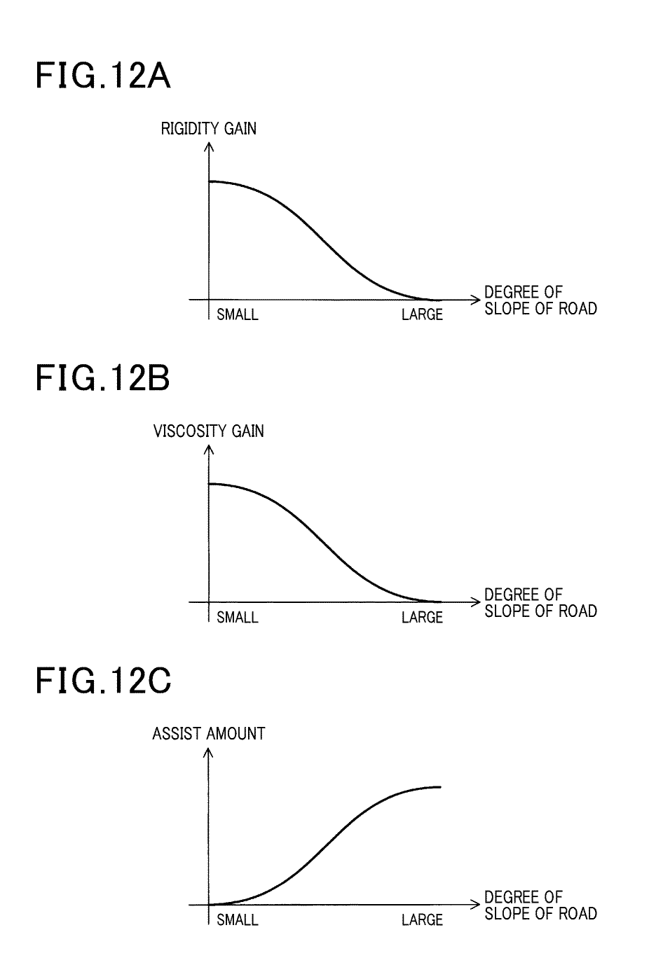

FIG. 12A is a view showing a relationship between the rigidity gain and the degree of the slope of an uphill road on which the own vehicle drives. FIG. 12B is a view showing a relationship between the viscosity gain and the degree of the slope of the uphill road on which the own vehicle drives. FIG. 12C is a view showing a relationship between the assist amount and the degree of the slope of the uphill road on which the own vehicle drives.

That is, the control section 10 determines various control parameter on the basis of information from the maps shown in FIG. 12A to FIG. 12C which have been prepared and represents the relationships between the control parameters and a degree of the road slope.

That is, the control section 10 adjusts and determines the rigidity gain, the viscosity gain and the assist amount according to the magnitude of the degree of road slope. The control section 10 increases the rigidity gain and the viscosity gain according to increase the degree of the slope of the uphill road. On the other hand, the control section 10 reduces the assist amount according to increase of the degree of the slope of the uphill road.

That is, when the own vehicle drives on an uphill road, the load applied to the front wheels of the won vehicle is in general reduced, the turning ability of the steering wheel of the own vehicle is reduced. Accordingly, the control section 10 adjusts the control parameters to maintain the degree of the turning ability of the steering wheel and to easily change the steering angle of the steering wheel. The control section 10 finishes the slope parameter setting process.

Next, the operation flow progresses to step S160 shown in FIG. 4. In step S160, the control section 10 executes the smoothing filter superimposing process. In the smoothing filter superimposing process, the control section 10 multiplying the curvature of the road with a predetermined filter value so as to obtain a smoothed curvature of the road. That is, the control section 10 adjusts and determines the control parameters on the basis of the smoothed curvature of the forward point on the road, through which the own vehicle would pass later (for example, N seconds later).

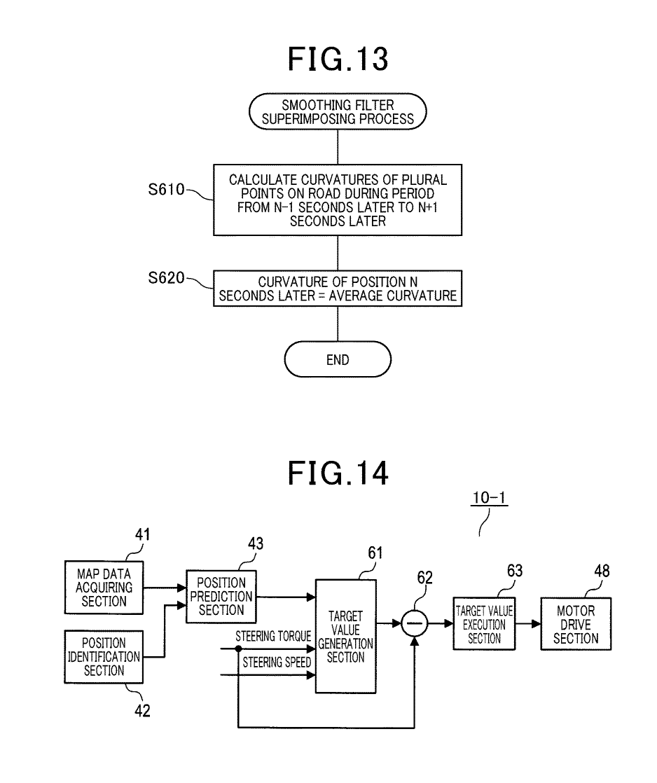

FIG. 13 is a flow chart showing the smoothing filter superimposing process executed by the drive assist system 1 according to the exemplary embodiment.

In step S610 shown in FIG. 13, in the smoothing filter superimposing process, the control section 10 calculates curvatures of plural positions on the road from a first forward position and a second forward position. The own vehicle would pass the first forward position on the road (N−t) seconds later, and the second forward position on the road (N+t) seconds later, where “t” is a predetermined optional value which has been determined according to the number of curvatures to be necessary for calculating an average value of those curvatures.

The operation flow progresses to step S620 shown in FIG. 13. In step S620, the control section 10 calculates an average value of the curvatures at plural positions on the road on which the own vehicle would pass during a period counted from (N−t) seconds later to (N+t) seconds later. The control section 10 determines the calculated average value of the curvatures as the calculated new curvature.

The control section 10 calculates the control parameters on the basis of the calculated new curvature. For example, it is acceptable for the control section 10 to adjust the control parameters to be adopted to the calculated new curvature.

After this process, the control section 10 finishes the smoothing filter superimposing process shown in FIG. 13, and the control parameter setting process shown in FIG. 4.

### (Effects)

A description will be given of the effects of the drive assist system 1 as the steering control device according to the exemplary embodiment.

(1a) In the drive assist system 1 as the steering control device according to the exemplary embodiment previously described, the control section 10 acquires information regarding the direction of the road on which the own vehicle drives, and obtains a drive direction of the road on the road. The control section 10 determines the control parameters so that the direction of the road matches with the drive direction of the own vehicle in order to easily perform steering operation using the steering wheel of the own vehicle according to the direction of the road.

According to the drive assist system 1 having the structure previously described, because the control section 10 adjust the control parameters so that the direction of the road matches with the drive direction of the own vehicle, it is possible to provide the stable operation using the steering wheel when the direction of the road matches with the drive direction of the own vehicle, and to increase the turning ability of the steering wheel of the own vehicle so as to match the direction of the road with the drive direction of the own vehicle when the direction of the road does not match with the drive direction of the own vehicle. When the own vehicle turns right or left, this control makes it possible to provide the improved turning ability of the steering wheel of the own vehicle while maintaining the stable steering operation using the steering wheel.

(1b) In the drive assist system 1 having the structure previously described, the control section 10 acquires the information regarding the road shape information of the road on which the own vehicle drives, and estimates the direction of the road according to the acquired road shape information. The control section 10 acquires the estimated direction of the road.

Because the control section 10 in the drive assist system 1 having the structure previously described estimates the direction of the road on the basis of the road shape information of the road on which the own vehicle drives, and determines the control parameters on the basis of the estimated direction of the road, it is possible for the control section 10 to execute the improved and stable drive control of the own vehicle even if the direction of the road is not directly obtained.

(1c) In the drive assist system 1 having the structure previously described, the control section 10 acquires at least one of the curvature of the road and the degree of the slope of the road, as the road shape information, on which the own vehicle drives. Because the control section 10 adjusts the control parameters on the basis of at least one of the curvature of the road and the degree of the slope of the road, this makes it possible to provide the improved stable steering operation using the steering wheel and the improved turning ability of the steering wheel of the own vehicle.
(1d) In the drive assist system 1 having the structure previously described, the control section 10 acquires the curvature of the road as the road shape information, and adjusts the control parameters so as to reduce the resistance degree of the steering operation using the steering wheel according to increase of the curvature of the road.

It is accordingly possible for the drive assist system 1 having the structure previously described to reduce the resistance degree of the steering operation using the steering wheel due to the increase of a magnitude of the curve of the road. The drive assist system 1 provides the easy steering operation to increase the steering angle according to the degree of a sharp curve road.

(1e) In the drive assist system 1 having the structure previously described, the control section 10 acquires the degree of the slope of the road as the road shape information, and adjusts the control parameters to reduce the resistance degree of the steering operation using the steering wheel according to increasing of a degree of the slope of an uphill road.

Because the control section 10 reduces the resistance degree of the steering operation using the steering wheel according to increase of the degree of the slope of the uphill road, this control makes it possible to easily increase the steering angle of the steering wheel even if the load of the front wheels of the own vehicle is reduced due to the degree of the slope of the uphill road.

(1f) In the drive assist system 1 having the structure previously described, the control section 10 acquires the road shape information at a forward position on the road in front of the own vehicle. According to the drive assist system 1 having the structure previously described, because the control section 10 adjusts and determines the control parameters on the basis of the road shape information of the forward position in front of the current position of the own vehicle on the road, it is possible to adequately adopt early operation of the driver of the own vehicle. This makes it possible to provide comfortable driving operation to the driver of the own vehicle.
(1g) In the drive assist system 1 having the structure previously described, the control section 10 determines the control parameter, as the direction of the road, on the basis of the smoothed curvature of the forward position on the road in front of the own vehicle. According to the drive assist system 1 having the structure previously described, it is possible for the control section 10 to obtain the control parameter without time delay from the current time when compared with the control parameter obtained on the basis of a previously-acquired curvature because of acquiring the smoothed curvature of the forward position on the road.
(1h) In the drive assist system 1 having the structure previously described, the control section 10, the control section 10 judges whether the current state of the own vehicle is in the steering angle increase state or the steering angle return state of the steering wheel. The control section 10 adjusts the control parameters so that the resistance degree of the steering operation using the steering wheel in the steering angle increase state becomes smaller than that in the steering angle return state.

Because of reducing the resistance degree of the steering operation in the steering angle increase state rather than in the steering angle return state, the drive assist system 1 having the structure previously described increases the turn ability of the steering operation using the steering wheel during the steering angle increase state, and maintains the stable drivability of the own vehicle during the steering angle return state of the steering wheel.

(1i) In the drive assist system 1 having the structure previously described, the control section 10 determines, as control parameters, at least one of the viscosity component, the rigidity component and the steering assist amount. The viscosity component and the rigidity component are mechanical impedances of the steering mechanism of the own vehicle.

According to the drive assist system 1 having the structure previously described, because at least one of the viscosity component, the rigidity component and the steering assist amount as the control parameters are determined, it is possible for the control device 10 to reliably adjust the turning ability of the own vehicle and the stable drivability of the own vehicle.

### (Other Modifications)

A description will now be given of various modifications of the drive assist system 1 as the steering control device according to the exemplary embodiment. It is acceptable for the drive assist system 1 as the steering control device according to the exemplary embodiment to have the following various modifications.

(2a) In the drive assist system 1 according to the exemplary embodiment having the structure previously described, the assist amount obtained by the assist control calculation section 46 and the control section 10 and the control amount obtained by the assist control calculation section 50 are added together, and the addition result is transmitted to the motor drive section 48.

However, the concept of the present invention is not limited by this structure. It is acceptable for the drive assist system 1 to have a control section 10-1 having another structure shown in FIG. 14, for example.

FIG. 14 is a view showing functional blocks of the control section 10-1 in the drive assist system 1 according to a modification of the exemplary embodiment.

In the structure shown in FIG. 14, the control section 10-1 has a target value generation section 61, a subtraction section 62, a target value execution section 63 instead of using the assist control calculation section 46, the addition section 47 and the assist control calculation section 50 in the control section 10 shown in FIG. 2.

The target value generation section 61 has a combination of a large part of the function of the assist control calculation section 46 and a large part of the function of the assist control calculation section 50. In more detail, the target value generation section 61 adjusts and determines a target value of a steering angle of the steering wheel, etc. according to a steering speed and the road shape information. The subtraction section 62 subtracts the steering torque from the determined target value of the steering angle.

The target value execution section 63 executes a PDI (proportional integral derivative) control which has been known, etc. The target value execution section 63 generates a control amount which is made to follow the value obtained by subtracting the steering torque from the target value as the output value of the subtraction section 62.

The structure of the control section 10-1 shown in FIG. 14 makes it possible to adjust and determine the target values such as the steering angle due to the curvature of the road, instead of due to the speed of the own vehicle. The structure of the control section 10-1 shown in FIG. 14 makes it possible to have the same effects of the structure of the control section 10 shown in FIG. 2.

(2b) The control section 10, 10-1 executes the smoothing filter superimposing process shown in FIG. 13 after the process in step S110 to step S150. However, the concept of the present invention is not limited by this. It is possible for the control section 10, 10-1 to execute the smoothing filter superimposing process at an optional timing after or before the process in step S110, and to adjust and determine the control parameters on the basis of the curvature of the road obtained by the smoothing filter superimposing process.
(2c) It is acceptable to combine the plural functions of one section in the control section 10, 10-1 to plural components, or to divide one function of one section in the control section 10, 10-1 to plural components.

Further, it is also acceptable to combine the plural functions of the sections in the control section 10, 10-1 to a single component, or to form one function, which is obtained by plural components, by using a single component. It is also acceptable to add a part of the components forming the control section 10, 10-1 to another component or components.

(2d) It is possible to realize the drive assist system 1, or the control section 10, 10-1 previously described by using programs and/or a non-transitory computer readable storage medium for storing those programs for causing a central processing unit in a computer system to execute the functions previously described.

### (Correspondence)

The drive assist system 1 used in the exemplary embodiment previously described corresponds to the steering control device.

The map data acquiring section 41 used in the exemplary embodiment previously described corresponds to the road shape information acquiring section.

The position identification section 42 used in the exemplary embodiment previously described corresponds to the drive direction acquiring section.

The position prediction section 43 used in the exemplary embodiment previously described corresponds to the road direction acquiring section and the road direction estimation section.

The assist control calculation section 50 used in the exemplary embodiment previously described corresponds to the control parameter determination section.

The parameter setting section 51 used in the exemplary embodiment previously described corresponds to the state judgment section.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A steering control device executing steering control of an own vehicle, comprising a computer system including a central processing unit (CPU), the computer system being configured to provide
a road direction acquiring section which acquires a direction of a road on which the own vehicle drives;
a drive direction acquiring section which acquires a drive direction of the own vehicle; and
a control parameter determination section which determines control parameters which define a degree of steering operation due to the direction of the road so that the direction of the road acquired by the road direction acquiring section easily matches with the drive direction of the own vehicle acquired by the drive direction acquiring section.

2. The steering control device according to claim 1, further comprising: wherein the computer system further provides
a road shape information acquiring section which acquires road shape information of the road on which the own vehicle drives; and
a road direction estimation section which estimates the direction of the road on which the own vehicle drives on the basis of the road shape information,
wherein the road direction acquiring section acquires the direction of the road estimated by the road direction estimation section.

3. The steering control device according to claim 2, wherein the road shape information acquiring section acquires at least one of a curvature and a degree of a slope of the road on which the own vehicle drives.

4. The steering control device according to claim 3, wherein the road shape information acquiring section acquires the curvature of the road on which the own vehicle drives, and the control parameter determination section determines the control parameters so that a resistance of a steering operation is reduced according to increase of the curvature of the road.

5. The steering control device according to claim 3, wherein the road shape information acquiring section acquires the degree of the slope of the road on which the own vehicle drives, and the control parameter determination section determines the control parameters so that a resistance of steering operation is reduced according to increase of the curvature of the road.

6. The steering control device according to claim 2, wherein the road shape information acquiring section acquires road shape information of a forward point on the road in front of a current location of the own vehicle.

7. The steering control device according to claim 3, wherein the road shape information acquiring section acquires road shape information of a forward point on the road in front of a current location of the own vehicle.

8. The steering control device according to claim 4, wherein the road shape information acquiring section acquires road shape information of a forward point on the road in front of a current location of the own vehicle.

9. The steering control device according to claim 5, wherein the road shape information acquiring section acquires road shape information of a forward point on the road in front of a current location of the own vehicle.

10. The steering control device according to claim 6, wherein the control parameter determination section determines the control parameters regarding the direction of the road on the basis of a smoothed curvature at the forward position on the road.

11. The steering control device according to claim 7, wherein the control parameter determination section determines the control parameters regarding the direction of the road on the basis of a smoothed curvature at the forward position on the road.

12. The steering control device according to claim 8, wherein the control parameter determination section determines the control parameters regarding the direction of the road on the basis of a smoothed curvature at the forward position on the road.

13. The steering control device according to claim 9, wherein the control parameter determination section determines the control parameters regarding the direction of the road on the basis of a smoothed curvature at the forward position on the road.

14. The steering control device according to claim 1, further comprising a state judgment section which judges whether the won vehicle is in a steering angle increase state or a steering angle return state, where a steering angle of a steering wheel of the own vehicle is increased in the steering angle increase state, and the steering angle of the steering wheel of the own vehicle is reduced in the steering angle return state,
wherein the control parameter determination section determines the control parameters so that when the steering wheel of the own vehicle is at an optional steering angle in the steering angle increase state, the resistance of the steering operation using the steering wheel is reduced when compared with in the steering angle return state.

15. The steering control device according to claim 2, further comprising a state judgment section which judges whether the won vehicle is in a steering angle increase state or a steering angle return state, where a steering angle of a steering wheel of the own vehicle is increased in the steering angle increase state, and the steering angle of the steering wheel of the own vehicle is reduced in the steering angle return state,
wherein the control parameter determination section determines the control parameters so that when the steering wheel of the own vehicle is at an optional steering angle in the steering angle increase state, the resistance of the steering operation using the steering wheel is reduced when compared with in the steering angle return state.

16. The steering control device according to claim 3, further comprising a state judgment section which judges whether the won vehicle is in a steering angle increase state or a steering angle return state, where a steering angle of a steering wheel of the own vehicle is increased in the steering angle increase state, and the steering angle of the steering wheel of the own vehicle is reduced in the steering angle return state,
wherein the control parameter determination section determines the control parameters so that when the steering wheel of the own vehicle is at an optional steering angle in the steering angle increase state, the resistance of the steering operation using the steering wheel is reduced when compared with in the steering angle return state.

17. The steering control device according to claim 4, further comprising a state judgment section which judges whether the won vehicle is in a steering angle increase state or a steering angle return state, where a steering angle of a steering wheel of the own vehicle is increased in the steering angle increase state, and the steering angle of the steering wheel of the own vehicle is reduced in the steering angle return state,
wherein the control parameter determination section determines the control parameters so that when the steering wheel of the own vehicle is at an optional steering angle in the steering angle increase state, the resistance of the steering operation using the steering wheel is reduced when compared with in the steering angle return state.

18. The steering control device according to claim 5, further comprising a state judgment section which judges whether the won vehicle is in a steering angle increase state or a steering angle return state, where a steering angle of a steering wheel of the own vehicle is increased in the steering angle increase state, and the steering angle of the steering wheel of the own vehicle is reduced in the steering angle return state,
wherein the control parameter determination section determines the control parameters so that when the steering wheel of the own vehicle is at an optional steering angle in the steering angle increase state, the resistance of the steering operation using the steering wheel is reduced when compared with in the steering angle return state.

19. The steering control device according to claim 1, wherein the control parameter determination section determines, as the control parameters, at least one of a viscosity component and a rigidity component in a mechanical impedance of a steering mechanism of the steering wheel, and an assist amount of the steering wheel of the own vehicle.

20. The steering control device according to claim 2, wherein the control parameter determination section determines, as the control parameters, at least one of a viscosity component and a rigidity component in a mechanical impedance of a steering mechanism of the steering wheel, and an assist amount of the steering wheel of the own vehicle.
